(19) United States
(12) Patent Application Publication
(10) Pub. No.: US 2006/0017395 A1
(43) Pub. Date: Jan. 26, 2006

(54) System and method for detecting and repairing

(75) Inventors: Meng-Chieh Liao, Hsinchu (TW); Chi-Chung Chen, Taipei (TW)

Correspondence Address: BIRCH STEWART KOLASCH & BIRCH, PO BOX 747, FALLS CHURCH, VA, 22040-0747, US

(73) Assignee: RITDISPLAY CORPORATION

(21) Appl. No.: 11/184,819

(22) Filed: Jul. 20, 2005

(30) Foreign Application Priority Data
Jul. 21, 2004 (TW) 093121826

(51) Int. Cl. G09G 3/10

(52) U.S. Cl. 315/169.3

(57) ABSTRACT

A system is to detect and repair defective pixels of an organic electroluminescent apparatus. The system comprises a pixel current detector, a controller and a beam generator. The pixel current detector detects the current of the driven pixel. The controller connects the pixel current detector to determine whether the current of the driven pixel is out of specification or not. When the pixel is out of the specification, the controller generates a first control signal. The beam generator connects the controller to generate a beam in accordance with the first signal, which is used to insulate or isolate the defective pixel. In addition, a method used in the system is also provided.

### BACKGROUND OF THE INVENTION

1. Field of Invention

The invention relates to a system and method for detecting and repairing and, in particular, to a system and method for detecting and repairing defective pixels of an organic electroluminescent apparatus.

2. Related Art

Information communication technology has become a major focus of the industry, especially the portable communication display products which are the point of development. Flat panel displays provide an interface between humans and information, thus they have become an important development direction of manufacturers. Present choices of flat panel displays include the plasma display panel (PDP), liquid crystal display (LCD), inorganic electroluminescence display (ELD), light-emitting diode (LED) display, vacuum fluorescence display (VFD), field emission display (FED), electro-chromic display, and the likes.

Compared to other flat panel displays, organic electroluminescent apparatuses, such as organic electroluminescent panels or organic electroluminescent devices, are self-emissive, and possess the advantages of full viewing angle, high power efficiency, easy manufacture, low cost, rapid response, and full color. Therefore, organic electroluminescent apparatuses may become the major choice for flat panel display technology in the future.

The organic electroluminescent apparatuses utilize the self-emissive properties of specific organic functional materials to achieve the objective of displaying. According to the different molecular weights of the organic functional materials, the organic electroluminescent apparatuses are classified into the small molecule OLED (SM-OLED) and the polymer light-emitting device (PLED). When applying the current to the two electrodes, the electrons and holes move and recombine in the organic functional material layer to generate excitons. The organic functional material layer can then radiate light of different colors according to their characteristics.

If particles exist on a pixel of the organic electroluminescent apparatus during manufacture thereof, the multiple layers of the pixel may be stacked abnormally. Additionally, the electrodes of the organic electroluminescent apparatus may contact each other and short-circuit. Consequently, the brightness, quality and reliability of the organic electroluminescent apparatus are decreased. Thus, it is critical to detect and repair defects of the products for ensuring the quality thereof.

To solve the above mentioned problems, the person of ordinary skill in the art usually utilizes a detection machine with an optical microscope and a repairing machine having a beam generator to detect and repair an organic electroluminescent apparatus.

In the conventional detection process, a detection machine with an optical microscope is used to scan an organic electroluminescent apparatus to determine whether pixel of the organic electroluminescent apparatus has defects or not, and then to position the location of the defect. In a subsequent step, the defective organic electroluminescent apparatus is transported to the repairing machine for a repairing process. In such a case, the defect is radiated with the beam generated by the beam generator, thus isolating the defect.

In view of the previously mentioned detection and repairing processes, it is necessary to check the enlarged images of the pixels of the organic electroluminescent apparatus for finding out the locations of the defects. However, this check method is manpower and time consumptive, and some defects may be undetectable due to artificial carelessness. In addition, the organic electroluminescent apparatus must be transported from the detection machine to the repairing machine for the consequent repairing process when the defects are detected. In practice, the detected defect(s) of the organic electroluminescent apparatus cannot be repaired directly because the organic electroluminescent apparatus is transported from the detection machine to the repairing machine. As with the prior process, the organic electroluminescent apparatus is scanned again in order to locate and then repair the defect.

As mentioned above, a foreign particle exists on the pixel may induce the stacking problem, and further induce a short-circuited issue. However, the defect caused by this particle can be ignored and is unnecessary to be repaired if the particle is smaller than a certain size and the short-circuited issue does not occur. In the conventional detection process, the defect is detected with the optical microscope by way of scanning. This method, however, cannot determine whether the defect will cause the short-circuited issue or not, and as a result, all detected defects will be repaired during the repairing process. Consequently, the conventional technology will scan an organic electroluminescent apparatus, locate defects, scan the device again, locate the defects again, and then repair all the detected defects, resulting in wasting time and resources in the manufacturing processes.

It is therefore an important subject of the invention to efficiently detect and repair defects of an organic electroluminescent apparatus.

### SUMMARY OF THE INVENTION

In view of the foregoing, the invention is to provide a system and method, which can efficiently detect and repair the defective pixel(s) of an organic electroluminescent apparatus.

To achieve the above, a system for detecting and repairing defective pixels of an organic electroluminescent apparatus, comprises a pixel current detector, a controller and a beam generator. The pixel current detector detects a current of a driven pixel when the organic electroluminescent apparatus is driven. The controller connected to the pixel current detector is for receiving the current of the driven pixel and for determining whether the current of the driven pixel is out of specification or not. When the current of the driven pixel is out of the specification, the controller generates a first control signal. The beam generator connected to the controller generates a beam in accordance with the first signal so as to insulate or isolate the driven pixel having the current out of the specification.

In addition, the invention also discloses a method for detecting and repairing defective pixels of an organic electroluminescent apparatus. The method comprises the following steps of: using a pixel current detector to detect a current of a driven pixel; using a controller to determine whether the current of the driven pixel is out of specification or not; generating a first control signal by the controller when the current of the driven pixel is out of the specification; and using a beam generator to generate a beam in accordance with the first signal for insulating or isolating the driven pixel having the current out of the specification.

As mentioned above, the system and method for detecting and repairing of the invention, in advance, uses the pixel current detector and controller to determine whether the current of the driven pixel is out of the specification. In the case that the current of the driven pixel is within the specification, it means that there is no defect existed in the driven pixel or only the small defect(s), which can be ignored, existed in the driven pixel. In another case that the current of the driven pixel is out of the specification, it means that there is one or more defects existed in the driven pixel. After that, the beam generator generates a beam to insulate or isolate the (defective) pixel having the current out of the specification. Therefore, it is unnecessary to separately provide a conventional detection machine and repairing machine to perform the detecting and repairing processes. Thus, the possible errors caused by artificial operations and the waste of manpower sources can be efficiently reduced. Moreover, the invention is to detect the current of the pixel for detecting the location of the defect, so that the location of the defect can be found out quickly and correctly. As a result, the defects of the pixel in the organic electroluminescent apparatus can be detected and repaired efficiently.

### BRIEF DESCRIPTION OF THE DRAWINGS

The invention will become more fully understood from the detailed description given herein below illustration only, and thus is not limitative of the present invention, and wherein:

FIG. 1 is a schematic view showing a system of detection and repair according to a preferred embodiment of the invention;

FIG. 2 is a schematic illustration of using the pixel current detector to detect the currents of the pixels in order;

FIG. 3 is a schematic illustration showing an image of a specific pixel of the organic electroluminescent apparatus, wherein the image is enlarged by a microscope and retrieved by an image-retrieving device;

FIG. 4 is a schematic illustration of using a precise distance-measurement device to detect the location of the organic electroluminescent apparatus; and

FIG. 5 is a flowchart showing a method of detection and repair according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

The system and method for detecting and repairing according to the preferred embodiment of the invention will be described herein below with reference to the accompanying drawings, wherein the same reference numbers refer to the same elements. To be noted, the organic electroluminescent apparatuses described in the following comprise organic electroluminescent panels and organic electroluminescent devices.

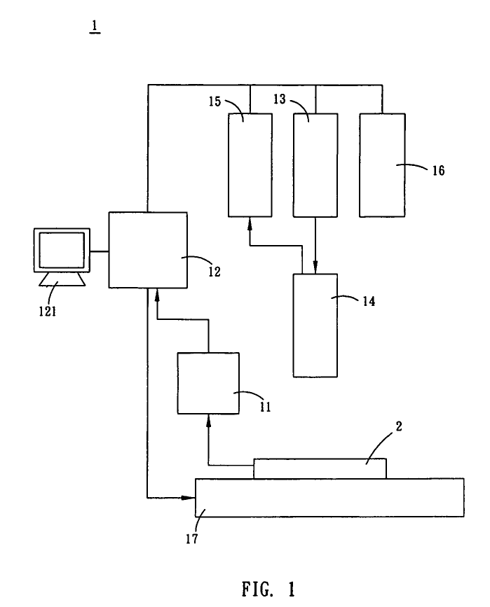

With reference to FIG. 1, a system of detection and repair 1 according to a preferred embodiment of the invention comprises a pixel current detector 11, a controller 12 and a beam generator 13. Furthermore, the system 1 may comprise a microscope 14, an image-retrieving device 15, a precise distance measurement device 16 and a stage 17. In the embodiment, the system 1 is used to detecting and repairing an organic electroluminescent apparatus 2, which includes a plurality of pixels.

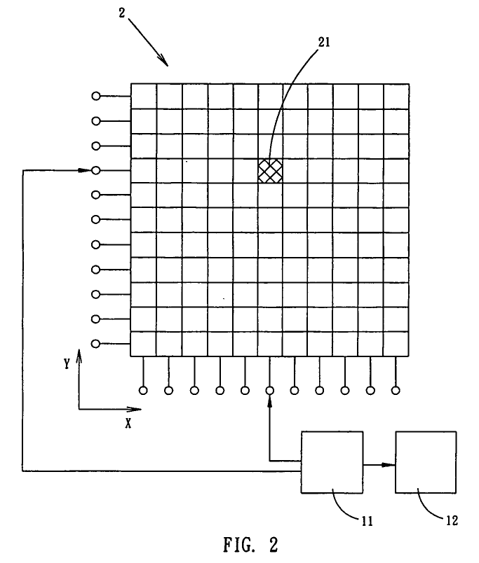

The pixel current detector 11 detects the current of the pixel of the organic electroluminescent apparatus 2 in order by a scan method. With reference to FIG. 2, the pixel current detector 11 connects to the organic electroluminescent apparatus 2. The two electrodes of the pixel current detector 11 are connected to one terminal in the X direction and one terminal in the Y direction, respectively. In this case, the two electrodes of the pixel current detector 11 connect to one terminal in the X direction and one terminal in the Y direction by a scan method, so that the pixel of the organic electroluminescent apparatus 2, such as the pixel 21 shown in FIG. 2, is connected in order. Then, the pixel current detector 11 can detect the current of the connected pixel 21, and the detected current is transmitted to the controller 12. The finished or semi-finished organic electroluminescent apparatus can be detected since this embodiment utilizes the pixel current detector 11 to detect the current of the pixel. To be noted, the semi-finished organic electroluminescent apparatus comprises two electrodes disposed on the substrate and an organic functional layer disposed between the electrodes. In addition, the finished organic electroluminescent apparatus comprises two electrodes disposed on the substrate, an organic functional layer disposed between the electrodes, and an encapsulating member such as a cover or an isolation layer. Moreover, the finished organic electroluminescent apparatus may comprise a polarizer, a brightness enhancement film (BEF), and/or an anti-reflecting (AR) layer disposed at the other side of the substrate.

Referring to FIG. 1 again, the controller 12 connects to the pixel current detector 11 and receives the current of the pixel detected by the pixel current detector 11, so that it can determine whether the current is out of the specification or not. When the current of the driven pixel is out of the specification, the controller 12 generates a first control signal. In the present embodiment, the current of the pixel may be interfered in accordance with the defect(s) if the pixel has one or more detects and is applied with a voltage. Therefore, the current of the pixel detected by the pixel current detector 11 is different with that of other pixel without defects. For example, when the controller 12 determines that the current of the pixel is out of the specification (such as 0.1 mA), it means that this pixel has the defect(s), which must be repaired. Accordingly, the controller 12 generates a first control signal for controlling the following repairing process of the organic electroluminescent apparatus. To be noted, the above-mentioned specification can be determined based on actual needs. In the current embodiment, the controller 12 is a computer connected to a display 121 for showing the outputted data from the controller 12.

The beam generator 12 connects to the controller 12 and generates a beam in accordance with the first control signal for insulating the driven pixel having the current out of the specification. In the embodiment, the beam can be a laser beam, an electron beam, a photon beam, a radiation beam or an ion beam, and is preferably a laser beam.

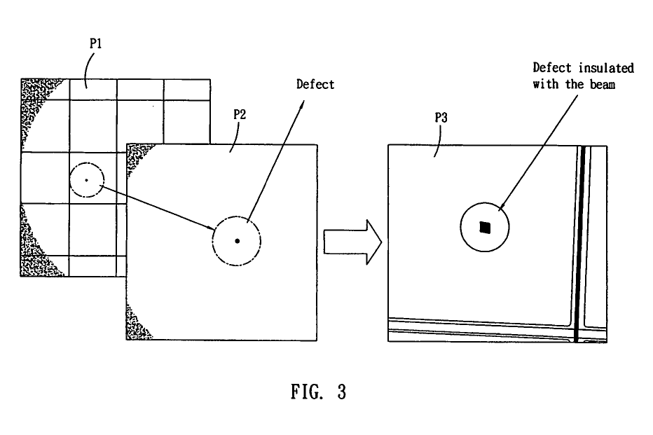

The microscope 14 is used to enlarge the image of the pixel of the organic electroluminescent apparatus 2. The image-retrieving device 15 connects to the microscope 14 and retrieves the enlarged image, such as P1 and P2 shown in FIG. 3, from the microscope 14. Then, the image retrieved by the image-retrieving device 15 is stored in the controller 12, and the controller 12 generates a second control signal for aligning the pixel and the beam generator 13 in accordance with the second control signal. The beam emits through the microscope 14. When current of the pixel is out of the specification, the controller 12 generates a first control signal for controlling the beam generator 13 to generate a beam. The controller 12 further generates the second control signal in accordance with the enlarged image for controlling the alignment of the pixel and the beam generator 13. Accordingly, the beam can be precisely controlled to align with the pixel having the defect(s), so the defect(s) can be repaired exactly (as P3 shown in FIG. 3). In this embodiment, the image-retrieving device 15 is a CCD camera.

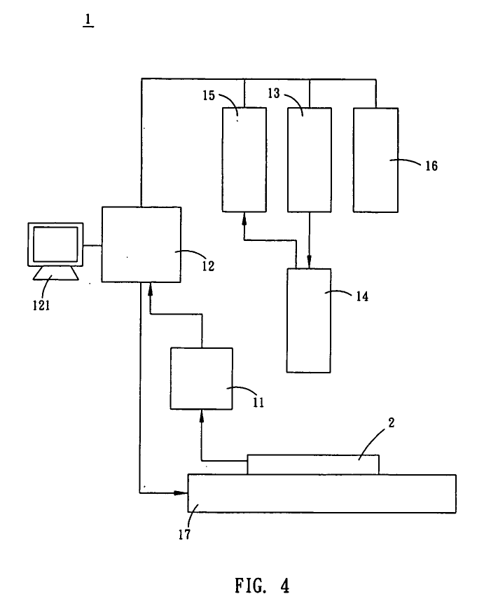

With reference to FIG. 4, before using the image-retrieving device 15 to retrieve the image enlarged by the microscope 14, the precise distance measurement device 16 automatically detects the location of the organic electroluminescent apparatus 2. In this case, the controller 12 generates a third control signal in accordance with the detecting location by the precise distance measurement device 16 for adjusting the distance between the microscope 14 and the organic electroluminescent apparatus 2 or the positions of the microscope 14 and the organic electroluminescent apparatus 2. In this embodiment, the precise distance measurement device 16 is a laser distance meter, which connects to the microscope 14 and generates a detecting signal such as a laser beam for determining the distance between the microscope 14 and the organic electroluminescent apparatus 2.

The stage 17 supports the organic electroluminescent apparatus 2 and moves the organic electroluminescent apparatus 2 and/or the microscope 14 for adjusting the distance between the microscope 14 and the organic electroluminescent apparatus 2 or the positions of the microscope 14 and the organic electroluminescent apparatus 2. Besides, the stage 17 moves the organic electroluminescent apparatus 2 and the beam generator 13 according to the second control signal to align them. Thus, the beam generated by the beam generator 13 can focus on the defective pixel.

As mentioned above, the stage 17 can move the organic electroluminescent apparatus 2 or the microscope 14 only; otherwise, it can move both the organic electroluminescent apparatus 2 and the microscope 14. Accordingly, the distance between the organic electroluminescent apparatus 2 and the microscope 14 or the positions of the organic electroluminescent apparatus 2 and the microscope 14 are adjusted. In this embodiment, the state 17 is an XYZ stage. Besides, a three-dimension control mechanism may be added on the microscope 14 for adjusting the distance between the organic electroluminescent apparatus 2 and the microscope 14. Thus, the location of the defective pixel and the microscope 14 can be aligned with the control of the three-dimension control mechanism.

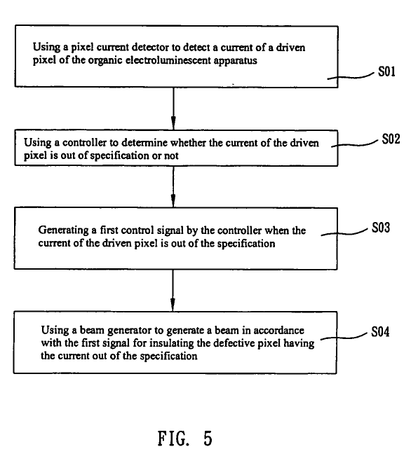

With reference to FIG. 5, a method of detection and repair according to the preferred embodiment of the invention will be described hereinafter. The method of detection and repair is applied in the previously mentioned system 1 for detecting and repairing an organic electroluminescent apparatus 2.

As shown in FIG. 5, a method of detection and repair according to the preferred embodiment of the invention comprises the following steps of: using a pixel current detector 11 to detect a current of a driven pixel of the organic electroluminescent apparatus 2 (step S01); using a controller 12 to determine whether the current of the driven pixel is out of specification or not (step S02); generating a first control signal by the controller 12 when the current of the driven pixel is out of the specification (step S03); and using a beam generator 13 to generate a beam in accordance with the first signal for insulating the defective pixel having the current out of the specification (step S04). In the embodiment, the beam can be a laser beam, an electron beam, a photon beam, a radiation beam or an ion beam, and the best one is laser beam.

In addition, to exactly find out the pixel having the defect, the method of the invention may further comprise the following steps of: using a microscope 14 to enlarge an image of the driven pixel; and using an image-retrieving device 15 to retrieve the enlarged image from the microscope 14. In the present embodiment, the image retrieved by the image-retrieving device 15 is stored in the controller 12, and the controller 12 generates a second control signal for aligning the defective pixel and the beam generator 13 in accordance with the second control signal. The beam further emits through the microscope 14.

Moreover, to precisely retrieve the enlarged image, the distance between the microscope 14 and the organic electroluminescent apparatus 2 must be exactly controlled. Thus, the method of the invention may further comprise the following steps of: using a precise distance measurement device 16 to detect a location of the organic electroluminescent apparatus 2; generating a third control signal by the controller 12 in accordance with the detecting result of the precise distance measurement device 16; and adjusting the distance between the microscope 14 and the organic electroluminescent apparatus 2 or the relative positions of the microscope 14 and the organic electroluminescent apparatus 2 in accordance with the third control signal. In this embodiment, the organic electroluminescent apparatus 2 is supported on a stage 17, and the stage 17 moves the organic electroluminescent apparatus 2 and/or the microscope 14 in accordance with the third control signal. Accordingly, the distance between the microscope 14 and the organic electroluminescent apparatus 2 or the positions of the microscope 14 and the organic electroluminescent apparatus 2 can be adjusted. Besides, the stage 17 may move the organic electroluminescent apparatus 2 and/or the beam generator 13 according to the second control signal to align them. Thus, the beam generated by the beam generator 13 can focus on the defective pixel for repairing it.

In summary, for detecting the defective pixel(s), the system and method for detecting and repairing of the invention, in advance, uses the pixel current detector and controller to determine whether the current of the driven pixel is out of the specification. In the case that the current of the driven pixel is within the specification, it means that there is no defect existed in the driven pixel or there is only the small defect(s), which can be ignored, existed in the driven pixel. In an alternative case that the current of the driven pixel is out of the specification, it means that there is at least one defect, which must be repaired, existed in the driven pixel. A subsequent repairing process, which uses a beam to insulate or isolate the (defective) pixel having the current out of the specification, is necessary. Therefore, it is unnecessary to provide a conventional detection machine and a conventional repairing machine to perform the detecting and repairing processes. Thus, the possible errors caused by artificial operations and the waste of manpower sources can be efficiently reduced. Moreover, the invention is to detect the current of the pixel for detecting the location of the defect, so that the location of the defect can be found out quickly and correctly. As a result, the defects of the pixel in the organic electroluminescent apparatus can be detected and repaired efficiently.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for detecting and repairing defective pixels of an organic electroluminescent apparatus, comprising:
a pixel current detector, which detects a current of a driven pixel;
a controller connected to the pixel current detector for receiving the current of the driven pixel and for determining whether the current of the driven pixel is out of specification or not, wherein when the current of the driven pixel is out of the specification, the controller generates a first control signal; and
a beam generator connected to the controller for generating a beam in accordance with the first signal so as to insulate or isolate the driven pixel having the current out of the specification.

2. The system of claim 1, further comprising:
a microscope, which is used to enlarge an image of the pixel; and
an image-retrieving device connected to the microscope for retrieving the enlarged image from the microscope.

3. The system of claim 2, wherein the image retrieved by the image-retrieving device is stored in the controller, and the controller generates a second control signal for aligning the defective pixel and the beam generator in accordance with the second control signal.

4. The system of claim 2, wherein the beam emits through the microscope.

5. The system of claim 2, wherein the image-retrieving device is a CCD camera.

6. The system of claim 2, further comprising:
a precise distance measurement device connected to the controller for detecting a location of the organic electroluminescent apparatus, wherein the controller generates a third control signal in accordance with the detecting result of the precise distance measurement device so as to adjust positions of the microscope and the organic electroluminescent apparatus.

7. The system of claim 6, further comprising:
a stage for supporting the organic electroluminescent apparatus and for moving the microscope and the organic electroluminescent apparatus in accordance with the third control signal so as to adjust the relative positions of the microscope and the organic electroluminescent apparatus.

8. The system of claim 6, wherein the precise distance measurement device connected to the microscope is for adjusting the distance between the microscope and the organic electroluminescent apparatus.

9. The system of claim 6, wherein the precise distance measurement device is a laser distance meter.

10. The system of claim 1, further comprising:
a display, which connects to the controller for showing outputted data from the controller.

11. The system of claim 1, wherein the controller is a computer.

12. The system of claim 1, wherein the organic electroluminescent apparatus is an organic electroluminescent panel or an organic electroluminescent device.

13. The system of claim 1, wherein the pixels are detected by a scan method.

14. The system of claim 1, wherein the beam is a laser beam, an electron beam, a photon beam, a radiation beam, or an ion beam.

15. A method for detecting and repairing defective pixels of an organic electroluminescent apparatus, comprising:
using a pixel current detector to detect a current of a driven pixel;
using a controller to determine whether the current of the driven pixel is out of specification or not;
generating a first control signal by the controller when the current of the driven pixel is out of the specification; and
using a beam generator to generate a beam in accordance with the first signal for insulating or isolating the defective pixel having the current out of the specification.

16. The method of claim 15, further comprising:
using a microscope to enlarge an image of the driven pixel; and
using an image-retrieving device to retrieve the enlarged image from the microscope.

17. The method of claim 16, wherein the image retrieved by the image-retrieving device is stored in the controller, and the controller generates a second control signal for aligning the defective pixel and the beam generator in accordance with the second control signal.

18. The method of claim 16, further comprising:
using a precise distance measurement device to detect a location of the organic electroluminescent apparatus;
generating a third control signal by the controller in accordance with the detecting location by the precise distance measurement device; and
adjusting positions of the microscope and the organic electroluminescent apparatus in accordance with the third control signal.

19. The method of claim 18, further comprising:
using a stage to support the organic electroluminescent apparatus and to move the microscope and the organic electroluminescent apparatus in accordance with the third control signal so as to adjust the positions of the microscope and the organic electroluminescent apparatus.

20. The method of claim 18, wherein the precise distance measurement device connected to the microscope is for adjusting the distance between the microscope and the organic electroluminescent apparatus.
